(19) United States
(12) Patent Application Publication
(10) Pub. No.: US 2002/0007595 A1
(43) Pub. Date: Jan. 24, 2002

(54) Method for reforming hydrocarbons autothermally

(76) Inventors: Uli Maier-Roeltgen, Muellheim (DE); Alexander Schuler, Freiburg (DE); Hartmut Finkbeiner, Baiersbronn (DE)

Correspondence Address: MARSHALL & MELHORN, FOUR SEAGATE, EIGHT FLOOR, TOLEDO, OH, 43604, US

(21) Appl. No.: 09/940,121

(22) Filed: Aug. 27, 2001

Related U.S. Application Data
(62) Division of application No. 09/446,642, filed on May 15, 2000.
Application No. 09/446,642 is a 371 of international application No. PCT/EP98/03869, filed on Jun. 24, 1998.

(30) Foreign Application Priority Data
Jun. 24, 1997 (DE) 197 27 841.8

(51) Int. Cl. C10B 57/00; B01J 7/00; C01B 15/00

(52) U.S. Cl. 48/116; 48/61; 201/2.5; 202/91

(57) ABSTRACT

The invention relates to a method and a device for autothermally reforming hydrocarbons. According to the invention, the fuel is fed to a reforming reactor via a feeding device. The resulting reformate is conveyed to the reforming starting materials in a heat exchanger in a reverse direction flow, in such a way that heat is exchanged, said starting materials being conveyed from the outside inwards. The fuel supplied by the feeding device is delivered directly to the reaction zone together with the starting material. Said reaction zone has a catalyst. The combustion and reforming or catalysis processes are then carried out simultaneously and in the same area in the reaction zone.

The invention relates to a device and a process for autothermal reforming of hydrocarbons, which are present, for example in the form of natural gas, benzine, methanol, diesel, liquified gas etc.

The industrial production of hydrogen from fossil fuels, such as natural gas, liquified gas or naphtha, is carried out mainly by the steam-reforming process in tubular furnaces filled with catalyst using indirect heating. The hydrogen-rich synthesis gases serve, for example to produce ammonia, alcohols or for methanol synthesis, but also for recovering the purest hydrogen. Complex process steps in separate reactor constructions are possible due to the size of the plants.

In addition to large-scale hydrogen production plants, special reformers have been developed in the course of fuel cell research, which are based on the so-called heat-exchange principle. The production capacity of hydrogen is in the order of a few 100 kW in these reformers based on the lower fuel value of the hydrogen volume flow. The high-temperature fuel cells SOFC or MCFC and the phosphoric acid fuel cell already sold commercially are used as hydrogen users for decentralized electricity production.

For smaller systems using polymer membrane fuel cells, in most cases methanol is selected as fuel with regard to mobile use, wherein autothermal reforming of methanol proceeds even at temperatures of 200° C. to 300° C. and compared to reforming of, for example methane, requires lower enthalpy of reaction.

The above-mentioned heat-exchange reformers are characterized by counter-current and co-current flow of the material streams waste gas and process gas. The reforming reaction takes place in tubular or annular gap reactors filled with solid catalyst, for example Ni/Al₂O₃. The flame burner lies in most cases centrally in the reforming unit or is flanged onto the reformer. The waste gases are then guided past in gaps on the reactor walls, where the thermal current required for the reaction is transferred convectively. The prerequisite for good conversions is adequately large transfer surfaces. The process gas after reforming is likewise passed in counter-current or co-current flow to the entering educt gas in order to utilize the high enthalpy stream of the synthesis gas at least partly for heating the educts and hence to save furnace power. The disadvantages of the existing reformers can be seen in that they cannot be adapted to small systems by simple scale-down, and in particular the thermal management is difficult to carry out in small reactors.

The object of the invention is to provide a process and a device for autothermal reforming of hydrocarbons, particularly in the small capacity range, which are suitable both for gaseous and liquid fuels, wherein undesirable reactions, such as soot formation, coking or thermal cracking, are avoided and good dynamic behavior is provided, and wherein in particular for mobile use the device should be designed to be small and compact.

This object is achieved according to the invention by the features of the main claim and the sub-claim.

Due to the fact that the fuel, mixed with starting materials of reforming, is applied directly to the hot catalyst of the reforming reactor and combustion and reforming takes place essentially in the same reaction region, undesirable reactions, such as thermal cracking, coking, soot formation, are largely avoided, since the critical temperature range from about 250° C. to 600° C. is passed through quickly, particularly for liquid hydrocarbons. This is assisted by the mixture preparation (fuel-air-steam) in the reactor, wherein the mixture is heated extremely quickly by the hot catalyst.

Reforming may take place using one and the same reactor construction for both gaseous and liquid fuels and also higher hydrocarbons, such as benzine or diesel.

Due to the possibility of spraying the hydrocarbon into already pre-heated air and possibly steam or even atomizing using pre-heated air and/or steam, or both, and due to heating of the educts, particularly the liquid droplets of the atomised hydrocarbon by heat reflection of the hot catalyst, into the inlet and mixing zone between nozzle and catalyst, rapid evaporation and heating, particularly of liquid hydrocarbons, is provided, so that the hydrocarbon is brought to process temperatures extremely quickly and the reaction may proceed immediately in the required direction.

At least some of the starting materials are preferably preheated in a heat exchanger in heat exchange with the reformate emerging from the reforming reactor.

To start the device, a brief starting time is facilitated by a small mass to be heated, the temperature of the catalyst can be freely adjusted by adding the starting materials formed, for example as air, and the hydrogen yield can be controlled by adding water or steam. Overall a high power density per system volume is achieved. Furthermore, a simple and compact integrative construction is provided, since a separate evaporator or an evaporating stage for liquid fuels is omitted, and external heating, that is a burner, is not necessary.

Furthermore, reaction of various hydrocarbons is possible in one device and the operation may be carried out both under pressure and without pressure. The quantity of hydrocarbon may be modulated within wide ranges (1:5 and more) and very small capacities are possible.

Autothermal reforming is carried out in a honeycomb catalyst and/or in a catalyst bed, wherein the reaction is facilitated at relatively low temperatures and material problems are avoided. Prior evaporation of the liquid hydrocarbon is not necessary. By providing the heat exchanger around the reaction zone, the air and/or the oxygen and/or the water and/or the steam used as starting material may be pre-heated and heat losses to the outside are avoided. Addition of air and/or oxygen and/or water and/or steam is possible via the supply nozzle, which may be designed as a binary nozzle, and the heat exchanger. Control of the process conditions may be carried out easily by adjusting the ratios of addition. Furthermore, the water or steam may also be added together with the hydrocarbon via the nozzle, resulting in soot formation and deposits being suppressed.

Advantageous further developments and improvements are possible due to the further measures indicated in the sub-claims.

Exemplary embodiments of the invention are shown in the drawing and are illustrated in more detail in the following description.

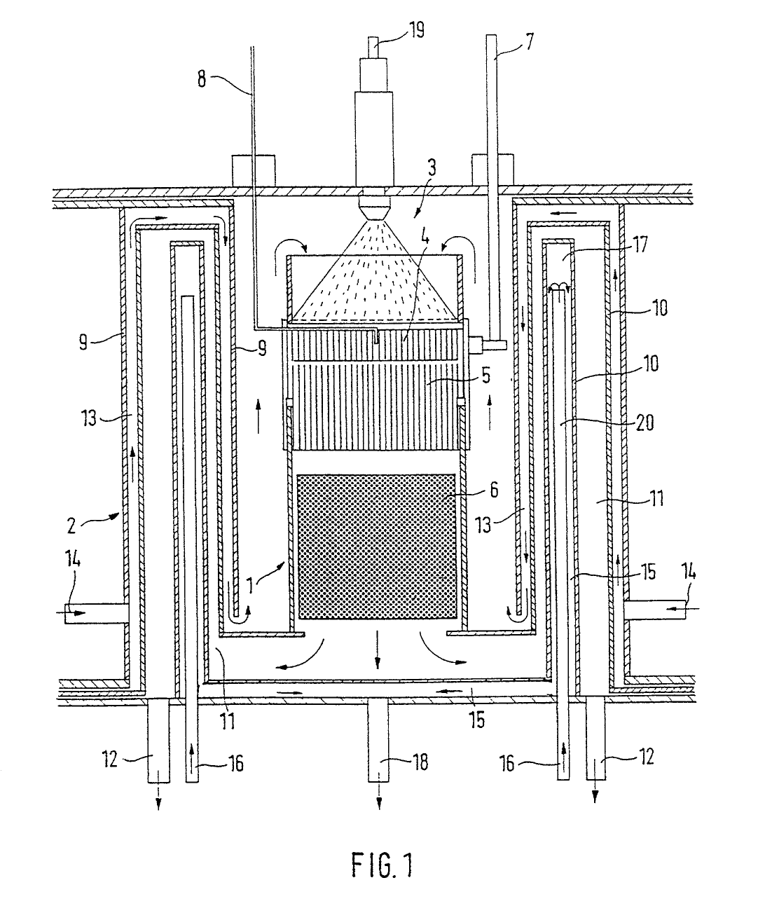

FIG. 1 shows a section through a first exemplary embodiment of the device of the invention,

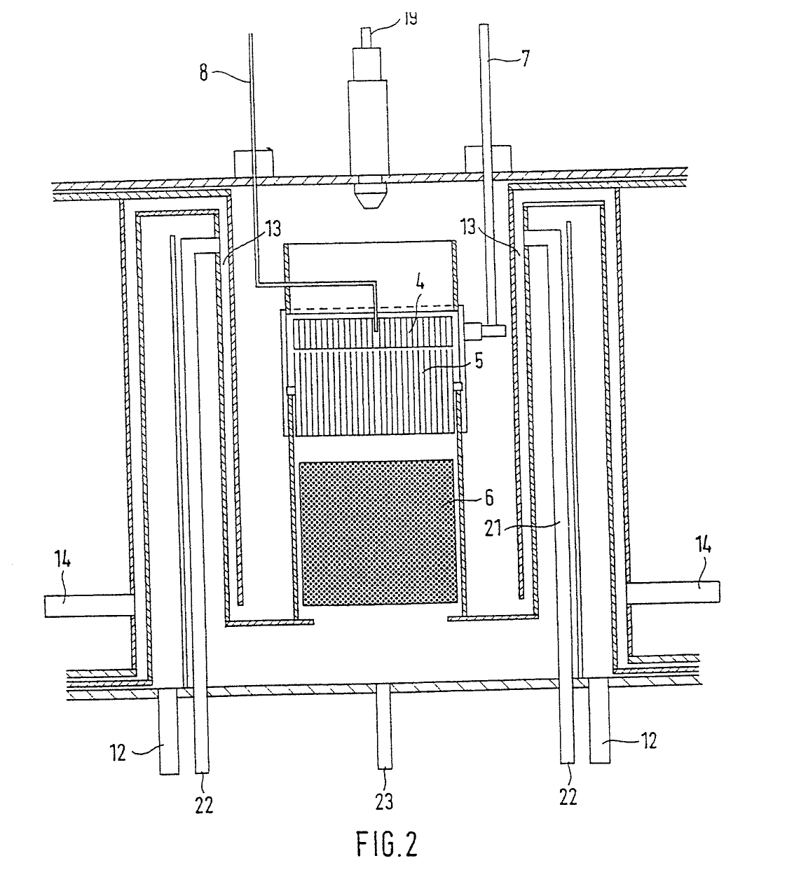

FIG. 2 shows a section through a second exemplary embodiment of the device of the invention,

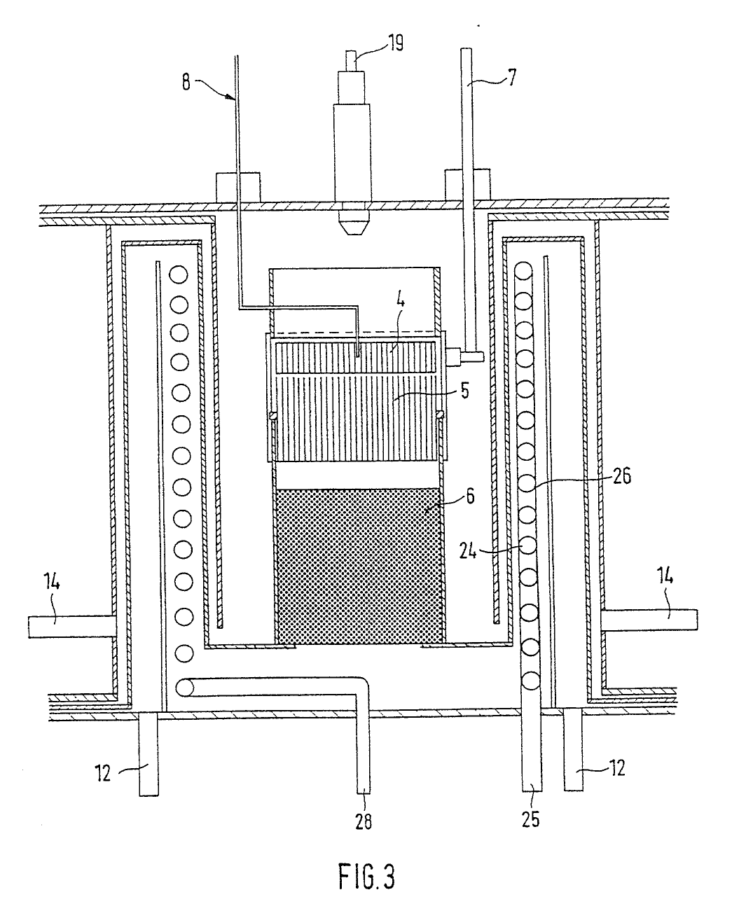

FIG. 3 shows a section through a third exemplary embodiment of the device of the invention, and

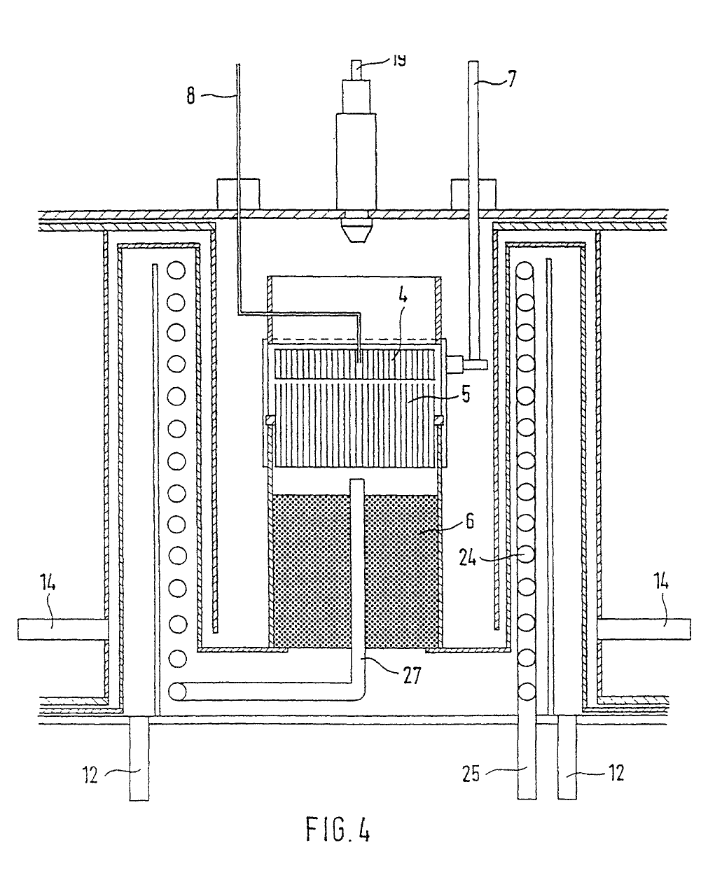

FIG. 4 shows a section through a fourth exemplary embodiment of the invention.

FIG. 1 shows a device for autothermal reforming, which catalytically converts liquid and/or gaseous hydrocarbons into synthesis gases. The device comprises a reforming reactor 1, a heat exchanger 2 and a spraying mixing chamber 3, which are realized in one construction or in one unit. The reforming reactor 1 comprises two regions, an upper region and a lower region, wherein the upper region has honeycombs 4, 5 and the lower region a bed 6. A first honeycomb 4 and a second honeycomb 5 separate from that are provided, wherein the honeycombs may consist of metal or ceramic and serve as supports for a catalyst. The honeycombs are therefore coated with a catalyst which consists of platinum or has nickel, but wherein any catalyst coating may be used, provided it is suitable for reforming. The same applies to the catalyst support. The bed is designed as a ceramic bed in the present exemplary embodiment, which is likewise coated with catalyst according to the above instructions.

Instead of the bed, a honeycomb or a corresponding permeable solid body provided with catalyst material may also be used, in which the pressure loss is lower.

A supply device for fuel designed as a nozzle 19, which emerges in the mixing chamber 3, is provided in the upper region of the device, wherein the nozzle 19 is designed as a single-componenet or preferably as a binary nozzle. Both the air, oxygen, steam and the water may be introduced together with the fuel, wherein the corresponding starting material is cold or pre-heated via the heat exchanger.

The essential basic concept of the process for autothermal reforming of hydrocarbons, which may be carried out using a device according to FIG. 1, is spraying a fuel-air or gas and/or steam mixture at temperatures of up to 250° C. onto a catalyst heated to, for example 600° C. or more, as a result of which for liquid fuel, fuel droplets resulting during spraying due to heat of radiation already partially evaporate before they meet the catalyst. Conversion of the fuel mixture takes place in the catalyst at any time purely catalytically, that is flameless.

Heating the fuel mixture to the required application temperature may be carried out via the heat exchanger.

To start operation of the reactor 1, the first catalyst 4 is heated electrically, which is indicated by the electrical lead 7. Instead of or in addition to electrical heating, an ignition device may be provided in the mixing chamber 3. In the starting phase the fuel is used together with supplied air for combusting and heating the catalyst to the required reaction temperature. In the subsequent reforming operation, the temperature is maintained by controlling the materials supplied.

A temperature sensor and connection lead 8, which serve to monitor the temperature, is provided in the region of the first honeycomb 4.

The heat exchanger 2 comprises several cylindrical walls 9 or cylindrical annular hollow bodies 10, which are arranged and interlocked so that they form at least two separate flow paths with several diversions. A flow path 11 for the reformate is connected to the lower end of the reforming reactor 1, at which the reformate emerges, is diverted upwards and then downwards and emerges in an outlet 12.

A further flow path 13 according to FIG. 1 is connected to an inlet connection 14 for air, oxygen, water and/or steam, is diverted downwards in the upper region of the device and emerges in the free chamber betwen heat exchanger 2 and reforming reactor 1, in the upper region of which the mixing chamber 3 is situated. Furthermore, a sealed flow path 15 is formed which is conected to an inlet 16 likewise for air, oxygen, water or steam, and subsequently thereto is restricted by a hollow annular pipe 17, is diverted downwards at the outlet of the annular pipe 17 and removed from the heat exchanger at the outlet 18. In the exemplary embodiment, the inlet or inlets 16 is or are connected to in each case a hollow pipe 20 projecting into the annular pipe 17, of which hollow pipes 20 several may be provided over the periphery. The flow path 15 serves to pre-heat the starting material and its outlet 18 may be connected to the inlet 14 or even to a supply device in the upper region of the device.

The heat exchanger 2 is, as the exemplary embodiemnt shows, arranged around the reaction chamber, wherein it comprises concentric pipes and in the thus resulting annular gaps the starting materials are passed from outside inwards to the heat, that is the supplied air, the oxygen, the steam and possibly the supplied water, in counter-current to the reformate in heat exchange with the latter. Hence the heat losses to the outside are minimized and expensive insulating measures adverse to the compact construction are avoided. The structue of the reforming reactor 1 and the at exchanger 2 must, as shown in the embodiment, permit heat expandison without inadmissible tensions in order to guarantee the tightness and material resistance of the reformer. This is achieved in that the annular pipes are arranged to be suspended in the hot central region and the parts of the heat exchanger are screwed only externally in the cold region for example.

At the start of operation of the device, the first honeycomb 4 is pre-heated and the fuel in liquid and/or gaseous form is introduced into the mixing chamber 3 via the nozzle 19 together with the starting material, which may be pre-heated, that is air and/or oxygen optionally steam, and sprayed directly onto the honeycomb 4. Hence combustion of the fuels is started. After reaching the necessary reforming temperature, there is transfer to the reforming operation by changing the air supply or oxygen supply and addition of water or steam, in which reforming and combustion proceed in parallel. Atomisation using steam effects better fuel conversion and furthermore minimizes possible soot formation. In that reforming reactor the catalytically assisted combustion and reforming itself are carreid out catalytically at the same time.

The temperature may be monitored via the sensor 8, wherein it is possible to adapt the temperature as a function of the measured value. During operation, the temperature, the material throughput and the temperature distribution in the catalyst may be influenced specifically. The free parameters are the air throughput (oxygen throughput), the fuel throughput and the water throughput, as well as the addition of air and water directly without pre-heating into the reaction zone or indirectly completely or partly via the heat exchanger into the reacton zone. Hence a high degree of ability for modulation using approximately constant product gas composition is possible. The flexibility of the reformer is an important criterion, particularly in connection with fuel cells which have excellent partial load behavior and are also operated there.

The reformate emerges, as indicated by the arrows in FIG. 1, from the bulk bed 6 at the bottom, is driven upwards in the flow path 11, diverted again in the upper region and emerges from the device at outlet 12. At the same time the starting material is introduced from the outside inwards into the reactor chamber in counter-current via the inlet 14 and the flow path 13, wherein the reformate releases its heat to the starting materials. In addition, air, oxygen, steam or water is introduced into the hollow pipe 20 via the inlet 16, diverted in the upper region and withdrawn again at outlet 18, wherein the materials are heated likewise by the heat of the reformate. Depending on requirement, flow through the heat exchanger 2 may be compelte, that is from inlet 16 via flow path 15 to outlet 18, wherein the flow may also be effected the other way around, that is the inlet is at 18 and the outlet at 16 and then from outlet 16 or 18 to inlet 14 and continues via flow path 13. However, flow may also only be partly via inlet 14 and flow path 13, or at 14 a mixture of the pre-heated strting material and fresh starting material may be supplied.

FIG. 2 shows a further exemplary embodiment, wherein one or more pipes 21 are provided here which emerge in the upper region of the device in the hot part of the heat exchanger 2 in flow path 13. Water or steam, which is mixed with the starting material supplied via inlet 14 at the hotter point of the heat exchanger 2, is added to the pipes 21 at inlet 22. This facilitates earlier addition of water or steam without the danger of condensing out and accumulation of water in the system, particuarly when running-up the system. The possibility of quenching down the reformate immediately after reforming, that is cooling down more quickly by spraying water, which suppresses possible carbon deposition, exists via a supply 23, which may be designed as a nozzle.

In FIG. 3 the heat exchanger 2 has an evaporator coil 24, wherein water or steam is passed via an inlet 25 in a pipe 26 into the upper region of the coil, in which complete evaporation takes place on the path downwards and the heated starting material may be removed at the outlet 28 and in turn may be supplied completely or partly to the inlet 14 or completely or partly to nozzle 19. Fuel may also be pre-treated in the evaporator coil 24 and supplied to the process accordingly.

The exemplary emdodiment according to FIG. 4 is similar to that according to FIG. 3, wherein fuel, water or steam, air and/or oxygen may be added to the inlet 25 of the evaporator coil. The outlet of the evaporator coil 24 is connected to a pipeline 27 which emerges directly in the chamber between second honeycomb 5 and bed 6. The material or materials introduced via inlet 25 are introduced into the reforming process after pre-heating via the evaporator coil 24 between the two catalysts, consisting of coated honeycomb 5 and coated bed 6. Hence the reforming process, that is the thermodynamic equilibrium, as well as the temperature, may be additionally strongly influenced or optimized. A pipeline corresponding to pipline 27 may also be introduced into the reaction zone directly without taking the path via the evaporator coil.

The inlets and outlets may be changed depending on the application so that the flow paths reverse their direction.

As already stated, fuels of different types, such as natural gas, benzine, methanol, diesel, liquified gas or the like, may be reformed in the above exemplary embodiments. The temperatures, to which the catalyst is heated, depend on the type of fuel. For example the temperature for diesel is more than 600° C., whereas for methanol 300° C. is sufficient.

1. Process for autothermal reforming of hydrocarbons, in which an essentially liquid and/or gaseous fuel mixed with a starting material of reforming is supplied to a reaction zone having a catalyst, wherein the catalyst is maintained at a temperature which prevents carbon formation, coking or thermal cracking, wherein the fuel is applied directly to the hot catalyst and the combustion and reforming is carried out catalytically at the same time.

2. Process according to claim 1, characterized in that the resulting reformate is passed in counter-current and in heat-exchanging manner with at least some of the starting material.

3. Process according to claim 1 or 2, characterized in that to start the reaction the catalyst is pre-heated electrically and/or the fuel is ignited for brief pure combustion by means of an ignition spark.

4. Process according to one of claims 1 to 3, characterized in that air and/or oxygen and/or water and/or steam is used as starting material.

5. Process according to one of claims 1 to 4, characterized in that pre-heated or non-pre-heated starting materials and/or fuel are introduced directly into the central region of the reaction zone.

6. Process according to one of claims 1 to 5, characterized in that the catalyst is heated and maintained at temperatures greater than 300° C. dependently of the fuel.

7. Process according to one of claims 1 to 6, characterized in that the fuel or the mixture fuel-starting material is supplied to the catalyst at a temperature less than 250° C.

8. Device for autothermal reforming of hydrocarbons having a supply device (19) for the fuel and a reforming reactor (1) which has a catalyst (4, 5, 6), wherein the supply device (19) is arranged with respect to the catalyst (4, 5, 6) such that the supplied fuel meets the catalyst directly which has a temperature essentially preventing carbon formation, coking or thermal cracking, and combustion and reforming takes place catalytically at the same time.

9. Device according to claim 8, characterized in that the reforming reactor (1) is arranged below the supply device (19), and in that a mixing chamber (3), in which the fuel is mixed with starting materials of reforming, is provided between supply device (19) and reforming reactor (1).

10. Device according to claim 8 or 9, characterized in that the catalyst of the reforming reactor (1) is designed as at least one permeable solid body (4, 5) coated with catalyst material.

11. Device according to one of claims 8 to 10, characterized in that the reforming reactor encloses a bulk bed (6) having catalyst material.

12. Device according to claim 10, characterized in that the permeable solid body is a metallic and/or ceramic honeycomb.

13. Device according to one of claims 10 to 12, characterized in that the permeable solid body has two superposed separate parts (4, 5), wherein the upper part can be pre-heated electrically.

14. Device according to one of claims 8 to 13, characterized in that the reforming reactor (1) is surrounded by a heat exchanger (2).

15. Device according to claim 14, characterized in that that the heat exchanger (2) has several concentrically arranged annular gaps, in which at least some of the starting materials of reforming are passed from outside inwards in counter-current with the reformate emerging from the reforming reactor (1).

16. Device according to one of claims 8 to 15, characterized in that the supply device has a nozzle (19) which sprays the fuel onto the catalyst material of the permeable solid body (4, 5).

17. Device according to claim 16, characterized in that the nozzle is designed as a binary nozzle, through which starting material is sprayed in addition to the fuel.

18. Device according to one of claims 14 to 17, characterized in that the heat exchanger (2) has an evaporator coil (24), through which flows the entire or some of the starting materials and/or fuel.

19. Device according to one of claims 14 to 18, characterized in that the heat exchanger (2) is connected to a pipe (27) which passes some of the starting material to the central region of the reforming reactor (1).
